(19) United States
(12) Patent Application Publication
(10) Pub. No.: US 2005/0158133 A1
(43) Pub. Date: Jul. 21, 2005

(54) Tile cutting attachment

(76) Inventor: Ronald Peter Hill, Sheffield (GB)

Correspondence Address: D Robertson;Armeg, Callywhite Lane, Dronfield Derbyshire, S18 2XJ, GB

(21) Appl. No.: 10/501,784

(22) PCT Filed: Jan. 17, 2003
(86) PCT No.: PCT/GB03/00180

(30) Foreign Application Priority Data
Jan. 19, 2002 (GB) 0201197.1

(51) Int. Cl. B23B 51/00

(52) U.S. Cl. 408/228

(57) ABSTRACT

A tile cutting attachment for the cutting of holes through tiles of a hard composition. Comprises a shaft (1) and a tip (2) for engaging the workpiece. The Shaft is provided with a profile to fit an industry standard drilling machine. The tip is provided with a plurality of edges each with sufficient clearance angle to provide a cutting edge to cut the workpiece. These edges combined with an adequate grade of material allow effective cutting of hard composition tiles.

### FIELD OF THE INVENTION

This invention relates to an attachment for a drilling machine, for use in the making of holes in hard composite tiles.

### BACKGROUND OF THE INVENTION

Many types of rotary glass & tile drills have been suggested in the past and have been in use for many years and find extensive use on building sites and other locations where there has been a necessity to drill tiles of a soft composition. None of which however have been entirely satisfactory for cutting holes in tiles of a hard composition.

While a diamond core drill will, of course, cut through tiles of a hard composition, experience has shown that a water spray must be employed to cool the drill while in operation or the diamonds will be lost. Not only does this necessitate the need for expensive drilling rigs in order to supply the cooling water, but the tiles become saturated with water which tends to make them incompatible with adhesives used to hold the tiles in place.

### OBJECT OF THE INVENTION

A basic object of the present invention is the provision of a tile drilling attachment that will produce holes in tiles of a hard composition. The invention is also designed to minimise the chipping of the hard material and particularly the glazed surfaces of the ceramic tile when a hole is being cut without the necessity of a cooling water supply.

### SUMMARY OF THE INVENTION

According to the present invention, there is provided a tile cutting attachment for the cutting holes in tiles of a hard composition comprising.
i. A tile drill bit having an active diameter of d.
ii. Comprising a shaft (a) and a tip (b) for engaging the workpiece.
iii. The tip is provided with a plurality of edges.
iv. Each edge is provided with a clearance angle (c), approx. 10°-20°, sufficient to provide a cutting edge to cut the workpiece as the drill bit rotates.
v. The tip should be provided with a point angle (p) of approx. 90°.
vi. The tip point should be given a relief angle (r) of approx. 60°.
vii. The point angle (p) & relief angle (r) should form a central point on the head of the tip.
viii. Secondary cutting edges should be provided with an overall angle (s) of approx. 30°.
ix. By virtue of the drill bit tip configuration a tile cutting attachment with improved performance is provided.
   Advantages of the Invention:

The invention provides an attachment that can produce holes in hard composite tiles, without chipping the material surface and without the need for water-cooling.

Preferred or optional features of the Invention:

The cutting tip has a protective, heat resistance coating produced from—TiN

The cutting tip has a protective, heat resistance coating produced from—TiAlCrN

The cutting tip has a protective, heat resistance coating produced from—TiCN

The cutting tip has a protective, heat resistance coating produced from—TiAIN/VN

The cutting tip has a protective, heat resistance coating produced from—Diamond

The cutting tip is manufactured from tungsten carbide

The cutting tip is manufactured from cermet

The cutting tip is manufactured from ceramic.

The tip should be attached to the shaft by means of brazing.

The tip should be attached to the shaft by means of welding.

The tip should be provided with 6 cutting edges.

The shaft should be manufactured from Carbon Steel.

The shaft should be manufactured from Alloy Steel.

### BRIEF DESCRIPTION OF THE DRAWINGS

One example of a Tile cutting attachment in accordance with the invention is shown in the accompanying drawings.

FIG. 1 is a front and side elevation of the tile cutting attachment;

FIG. 2 is a front and side elevation of the proposed cutting tip;

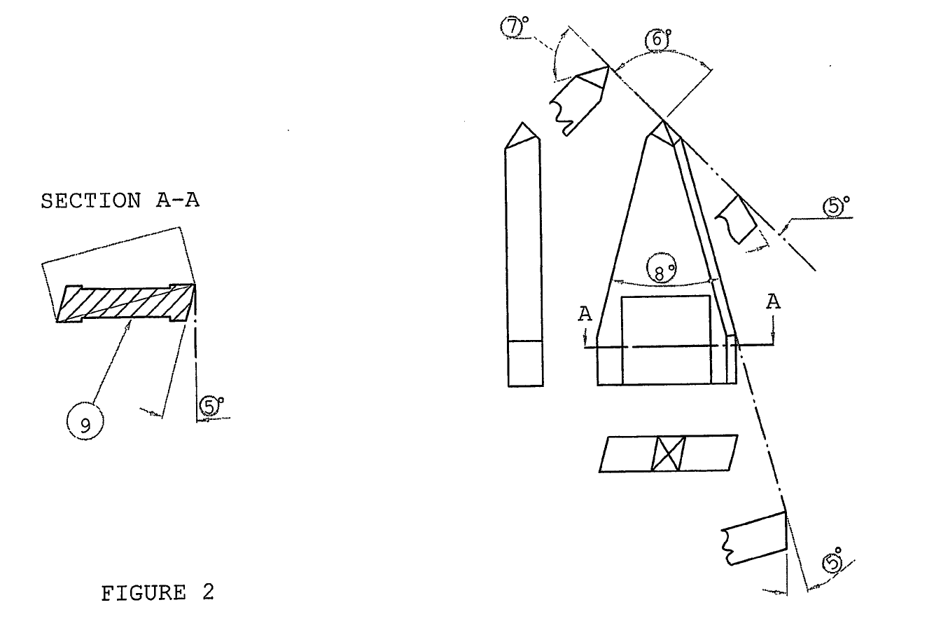

### DETAILED DESCRIPTION OF THE DRAWINGS

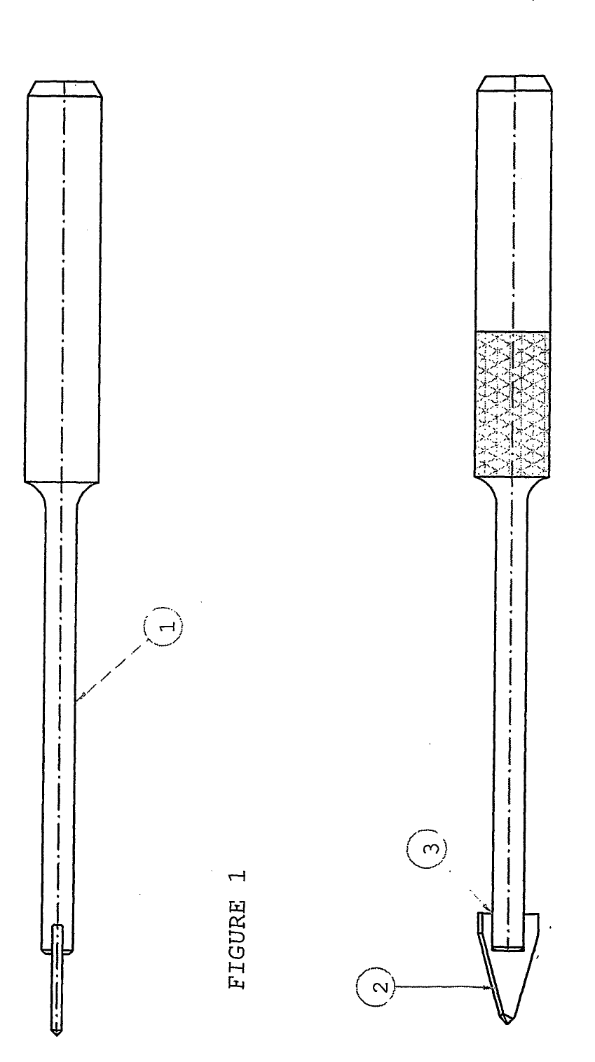

A tile cutting attachment, FIG. 1, for use in producing circular holes in hard composition tiles comprising a shaft 1 having a tip 2 attached by means of brazing 3 to the shaft 1. The shaft 1 is profiled at one end to enable fitment to an industry standard drilling machine 4.

The tip 2 encompasses a plurality of cutting edges with adequate clearance 5 (10-20°). The tip 2 is provided with a point 6 (90°) to enable accurate location and assist in the start of drilling. The point 6 is provided with adequate an adequate clearance angle 7 (60°) to provide a cutting edge.

Secondary cutting angles are also provided 8 (30°).

The tip 2 has a recess 9 to allow accurate centralisation to the shaft 1.

1. Comprising a shaft (1) and a tip (2) for engaging the workpiece.

2. The tip is provided with 6 cutting edges.

3. Each edge, as claimed in claim 3, is provided with a clearance angle (c), approx. 10°-20°, sufficient to provide a cutting edge to cut the workpiece as the drill bit rotates.

4. The tip as claimed in claims 3 and 4, should be provided with a point angle (p) of approx. 90°.

5. The point as claimed in claim 5, should be given a relief angle (r) of approx. 60°.

6. The point angle (p) & relief angle (r) as claimed in claim 4 and 5, should form a central point on the head of the tip

7. Secondary cutting edges should be provided with an overall angle (s) of approx. 30°.

8. A tile drill bit having an active diameter of d.

9. The cutting tip, as in claim 2, is manufactured from tungsten carbide.
